(19) United States
(12) Patent Application Publication
(10) Pub. No.: US 2007/0098919 A1
(43) Pub. Date: May 3, 2007

(54) Method for fabricating optical compensation film

(76) Inventors: Kuang-Rong Lee, Ping Chen City (TW); Tan-Ching Wan, Ping Chen City (TW); Ming-Jian Shao, Ping Chen City (TW); Yu-Hwey Chuang, Ping Chen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/362,199

(22) Filed: Feb. 27, 2006

(30) Foreign Application Priority Data
Oct. 27, 2005 (TW) 94137618

(51) Int. Cl. C09K 19/00

(52) U.S. Cl. 428/1.1

(57) ABSTRACT

The present invention provides a method of forming an optical compensation film. The method employs biphenyl polyimide without fluorine and combines negative C plate with A plate to be applied to the view-angle compensation film of TFT-LCDs.

### RELATED APPLICATIONS

The present application is based on, and claims priority from, Taiwan Application Serial Number 94137618, filed Oct. 27, 2005, the disclosure of which is hereby incorporated by reference herein in its entirety.

### BACKGROUND

1. Field of Invention

The present invention relates to an optical compensation film. More particularly, the present invention relates to a method for forming an optical compensation film of C+A plate type.

2. Description of Related Art

The characteristics of rotating polarized light and the birefringence of liquid crystal molecules are used in liquid crystal displays (LCD) to achieve displaying bright and dark regions. Display quality of LCDs depends upon the viewing angle of each viewer. When developing large scale LCDs, it is important to consider and improve the range of these viewable angles. New and improved techniques to obtain broader ranges of viewing angles comprise using optical compensation films

Generally, optical compensation films used in the prior art are differentiated among the optical-axis distribution, so the main classifications are (a) C-plate; (b) optical compensation films having spin structure; (c) optical compensation films having bi-axial optical properties; and (d) optical compensation films having discotic liquid crystal. Usually, the optical compensation films are of two types of films (positive and negative), which are stuck on liquid crystal panels. Rod-like molecules are used in positive optical compensation films; and negative optical compensation films are fabricated by polyimide (PI) or discotic liquid crystal and used to improve the viewing angles of the displays.

The optical compensation films of the negative C-plate type typically have optical properties of nx=ny>nz, such as Harris et. al. disclosed (“Polymer”, vol. 37, from pp. 5321, 1996). Because the optical compensation films of C-plate type have nx=ny, they do not affect the display qualities of the LCDs in the vertical direction. Furthermore, the negative birefringence of the C-plate is precisely opposite to the positive birefringence of the rod-like molecules (Δn=nz−nx<0). Hence, the optical compensation films are suitable to compensate for light leakage which results from the liquid crystal molecules being arranged perpendicular to the substrates in crystal devices and increase the vertical viewing angles. The optical compensation of the A-plate type has nx=nz, wherein the positive A-plate is nx>ny=nz and the negative A-plate is nx<ny=nz.

The high polymer films are pulled to be used as the traditional retardation films, such as TAC, PC and COP (as disclosed in JAPAN Publication No. H03-033719, JAPAN Publication No. H03-024502, JAPAN Publication No. H04-194820, U.S. Patent No. 2004-0046272, JAPAN Publication No. H15-255102, JAPAN Publication No. H13-215332, JAPAN Publication No. H10-045917, JAPAN Publication No. H01-132625, JAPAN Publication No. H 1-132626, JAPAN Publication No. H02-133413, JAPAN Publication No. S63-218726, and JAPAN Publication No. S61-115912).

Various people have disclosed polyimide having in-plane phenyl in the main chain to be polymeric material for fabricating the negative C-plate type film to be spread on inorganic substrates (as disclosed in U.S. Pat. No. 5,071,997, U.S. Pat. No. 5,344916, U.S. Pat. No.5,395,918, U.S. Pat. No. 5,480,964, U.S. Pat. No. 5,580,950, U.S. Pat. No. 6,074,709, U.S. Pat. No. 6,303,743, and Japanese translation of PCT No.8-511812). This polymeric material is spread on uniaxially extended substrates or on substrates that are re-extended (as described in WO2003/071319, WO2004/011970, JAPAN Patent 2003/009568, JAPAN Patent 2003/344657A2, JAPAN Patent 2004/004474, JAPAN Patent 2004/004755, JAPAN Pat 2004/226945, JAPAN Patent 2005/091625, JAPAN Patent 2005/114836, etc.). In addition, JAPAN Patent 2004/004474 also disclosed spreading the polyimide on the substrates and adhering PVA to form a polarizer as well as forming the polarizer using the A-plate type film (the uniaxially extended substrates) adhered to the PVA.

The materials described above, however, are neither stable in shape nor adhesive properties due to such high water-absorbing ratios of cellulose acetate thin film. Furthermore, because the high content of a low molecular weight retarder, the materials are not as durable as compared to cyclopylene polymer. In addition, the resin of an aromatic retardation compound has good wavelength dispersion properties because of its absorption of visible light.

Furthermore, discotic liquid crystal cannot be used by itself, but needs to be spread evenly and not more than several microns thick on transparent substrates. Besides the high cost of spreading, the larger birefringence of the circular form of the liquid crystal has slight variation in spreading thickness and results in larger phase difference. Moreover, pollutants, such as residue on the surfaces of the spread thin films or dust in the liquid solution of the circular form, may also cause optical flaws.

The extension of the high polymeric films used in the prior art require controlling the extension ratio and direction precisely. Since the traditional manor of spreading polyimide on the inorganic substrates cannot be used directly, the transferred adhering technique must be employed. These problems of the prior art are unduly complicate fabrication and drive cost of the inorganic substrates higher. The prior art of spreading polyimide, fluorine-containing biphenyl polyimide, on the uniaxially extended substrates of the C+A plate type optical compensation films provides a single plane but exhibits serious color dispersion.

Therefore, the invention provides an optical compensation film without the above mentioned problems. The invention is low in cost and easily fabricated. Biphenyl polyimide without fluorine are coated on C+A plate type optical compensation films to provide compensation films for viewing angles of TFT-LCDs.

### SUMMARY

Therefore, a C+A plate optical compensation film having negative birefringence and a fabricating method thereof solves the above mentioned problem and accomplishes the present invention.

In accordance with the foregoing and other objectives of the present invention, a method for forming an optical compensation film of C+A plate type is provided.

According to one preferred embodiment of the present invention, a method is characterized by dissolving a predetermined percentage of polyimide homogeneously in a solvent according to required properties to obtain a solution, wherein the polyimide is biphenyl polyimide without fluorine, and then spreading the solution on at least one surface of a uniaxially extended A plate substrate to form an optical compensation film of C+A plate type.

The invention provides an optical anisotropic film of C+A plate type that is fabricated by the method as one preferred embodiment.

According to another preferred embodiment of the present invention, a method is characterized by dissolving a predetermined percentage of polyimide homogeneously in a solvent according to required properties to obtain a solution, wherein the polyimide is a biphenyl structure without fluorine, and then spreading the solution on at least one surface of a substrate and re-extending the substrate to form an optical compensation film of C+A plate type.

In accordance with the present invention, the invention provides less complicated and less costly fabrication without precisely controlling the extension ratio and direction. The polyimide having a biphenyl structure without fluorine is coated on the C+A plate type optical compensation films, which are used as the compensation films for viewing angles of TFT-LCDs. The optical compensation films of C+A plate type having negative birefringence are used as the polyimide thin films of compensation films for viewing angles of TFT-LCDs.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings, FIG. 1 is a schematic of color shift of a C+A plate type optical compensation film in different white modes, Rth and R0, according to the fabricating method of the present invention;

FIG. 2 is a schematic of color shift of C+A plate type optical compensation film in different black modes, Rth and R0, according to the fabricating method of the present invention; and

FIG. 3 is a schematic of color shift of C+A plate type optical compensation film in different color modes, red, green and blue of Rth and R0, according to the fabricating method of the present invention.

### DESCRIPTION OF THE PREFERRED EMBODIMENTS

The invention can be more fully understood by the following detailed description of C+A plate type optical compensation films having negative birefringence and the method thereof.

The method for fabricating a C+A plate type optical compensation film comprises dissolving a predetermined percentage of polyimide homogeneously in a solvent according to required properties to obtain a solution, wherein the polyimide is a biphenyl polyimide without fluorine; and spreading the solution on at least one surface of a uniaxially extended A plate substrate, or spreading the solution on at least one surface of a substrate and re-extending the substrate, or spreading on at least one surface of a substrate and re-adhering to PVA to form an optical compensation film of C+A plate type of single or double planes.

The solvent used in the invention is not specifically limited; for example, the solvent can be an alkyl halide, aromatic, ketone ring, ether, ketone, or a combination thereof. Of these, the alkyl halide can be dichloromethane, dichloroethane, trichloroethane, tetrachloroethane or a combination thereof, the aromatic can be toluene, the ketone ring can be cyclopentanone, cyclohexanone or a combination thereof, the ether can be tetrahydrofuran (THF), and the ketone can be acetone, methyl-ethyl ketone (MEK), methyl-isobutyl ketone (MIBK), methyl-isoproyl ketone (MIPK), 1-methyl pyrrolidone (NMP), dimethyl sulfoxide (DMSO) or a combination thereof.

Accordingly, the method for fabricating the C+A plate optical compensation film comprises dissolving a predetermined percentage of polyimide homogeneously in a solvent as described above according to required properties to obtain a solution, wherein the polyimide is a biphenyl structure without fluorine. The C+A plate optical compensation film is produced by spreading the solution on at least one surface of a uniaxially extended A plate substrate, or spreading the solution on at least one surface of a substrate and re-extending the substrate, or spreading on at least one surface of a substrate and re-adhering to PVA. The fabricated C+A plate optical compensation film of single or double planes can be applied to optical electronics flat panel displays, especially to super twisted nematic (STN), twisted nematic (TN), in-plane switching (IPS), vertically aligned (VA), optically compensated birefringence (OCB), or axially symmetric aligned micro (ASM) LCDs to increase viewing angles of the optical compensation films of C+A plate type having negative birefringence.

The spreading method used in the invention is not specifically limited; for example, forming the homogeneously optical thin films can be achieved by roller painting, spin coating, blade spreading, etc. . . .

The embodiments of the present invention are illustrated as follows, but the invention is not limited to the illustrated embodiments.

Polyimide is dissolved in cyclopentanone solvent at room temperature. The spreading concentration of the polyimide is 10% and the viscosity of the polyimide is measured at 25° C. Then, different sizes of wire bar are used to spread the polyimide on glass, of which the spreading area is about 20×20 cm² to obtain the appropriate value of Rth. The polyimide/glass is put in an oven for about 10 minutes and dried at 80° C. for 30 min to obtain the formed films of MRL series of PI (BIBB-1). Then, inorganic material is used to adhere the PI thin film to TAC substrates. The value of Rth is obtained by applying a Kobra measurement to the simply adhering films of PI/TAC. Then, inorganic material is used to adhere PI/TAC and PVA/TAC to form the lower polarizer (7×7 cm²). The upper polarizer and the lower polarizer are collocated to obtain the C+A plate optical compensation film and then the optical contrast measurement is proceeded by using an AU19“EN03” panel.

The above mentioned measurement of the Rth is proceeded by the KOBRA-21 ADH optical birefringence analyzer. First, the PI thin film of 4×4 cm² is put in the measurement location, and the thickness of the polyimide thin film is input. The polyimide thin film is measured at intervals of 10° angles between −50° to 50°. After the measurement is finished, the refraction of the polyimide thin film is input and then the R0, Rth, aligned angle, Nx, Ny and Nz are obtained. An EZContrast 160R is used to measure contrast, viewing angles, color shift and other the optical properties. First, the panel is put in a location waiting measurement, and a camera lens is focussed on the polarizer. Then, the optical properties of white mode, black mode, color (red, green, blue) are proceeded to be measured.

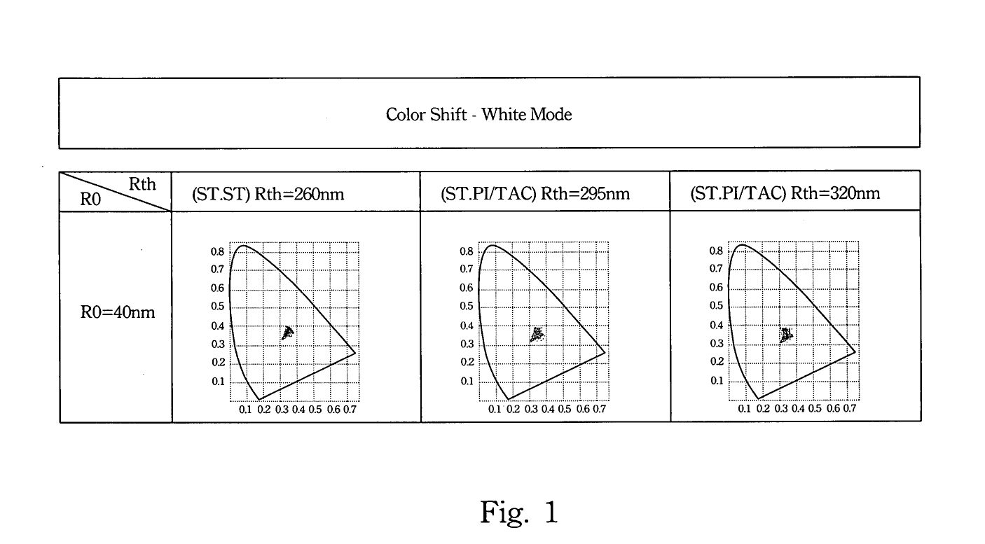

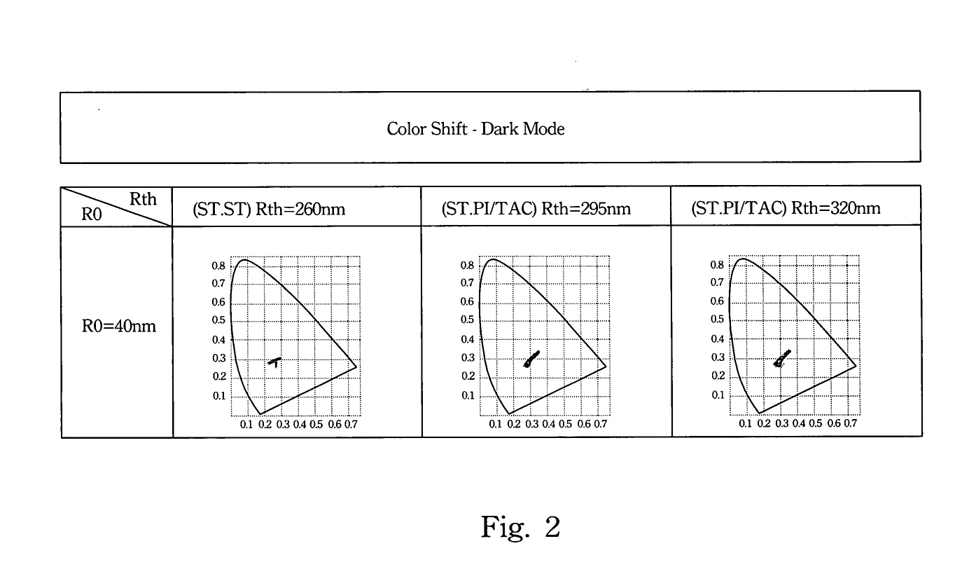

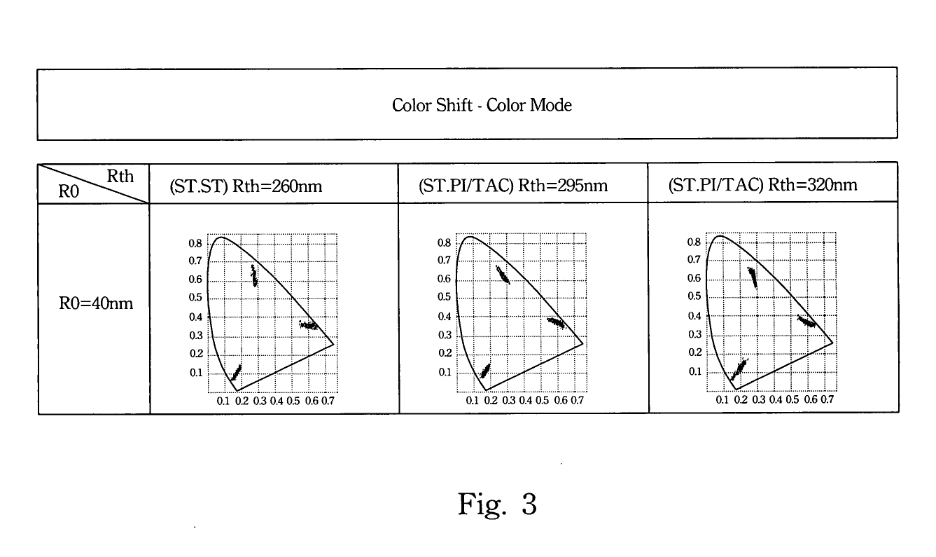

The results are illustrated in the Table 1, FIG. 1, FIG. 2 and FIG. 3.

TABLE 1

| | | | View-angles (CR > 20) | | | |
|---|---|---|---|---|---|---|
| Sample | (R0, Rth) | CRmax | 0 | 180 | 45 | 135 |
| ST/ST | 40,260 | 812 | 80 | 80 | 52 | 52 |
| ST/PI/TAC | 40,295 | 970 | 80 | 80 | 59 | 59 |
| ST/PI/TAC | 40,320 | 940 | 80 | 80 | 55 | 55 |

ST = the re-extended TA;
CR = contrast

According to the results as shown in Table 1, FIG. 1, FIG. 2 and FIG. 3, the optical properties, such as the contrast, viewing angles and color shift, of the optical compensation film of the invention are better than the conventional optical compensation film.

In accordance with the invention, the optical compensation film can be fabricated and spread inexpensively and simply to obtain a C+A plate type optical compensation film of biphenyl polyimide without fluorine. The formed optical compensation film of C+A plate type can be applied to a view-angle compensation film of a TFT-LCD.

What is claimed is:

1. A method for forming an optical compensation film of C+A plate type, the method characterized by:
dissolving a predetermined percentage of polyimide homogeneously in a solvent according to required properties to obtain a solution, wherein a structure of the polyimide is a biphenyl structure without fluorine; and
spreading the solution on at least one surface of a substrate of uniaxially extended A plate to form an optical compensation film of C+A plate type.

2. The method of claim 1, wherein the solvent is selected from the group consisting of alkyl halides, aromatic, ketone ring, ethers, ketone and combinations thereof.

3. The method of claim 2, wherein the alkyl halide is selected from the group consisting of dichloromethane, dichloroethane, trichloroethane and tetrachloroethane.

4. The method of claim 2, wherein the aromatic is toluene.

5. The method of claim 2, wherein the ketone ring is cyclopentanone or cyclohexanone.

6. The method of claim 2, wherein the ether is tetrahydrofuran (THF).

7. The method of claim 2, wherein the ketone is selected from the group consisting of acetone, methyl-ethyl ketone (MEK), methyl-isobutyl ketone (MIBK), methyl-isoproyl ketone (MIPK), 1-methyl pyrrolidone (NMP) and dimethyl sulfoxide (DMSO).

8. An optical anisotropic film of C+A plate type, wherein the optical anisotropic film of C+A plate type is fabricated by the method as claimed in claim 1.

9. The optical anisotropic film of C+A plate type of claim 8, wherein the optical anisotropic film of C+A plate type is applied to a functional optical film of flat panel displays.

10. The optical anisotropic film of C+A plate type of claim 8, wherein the optical anisotropic film is applied to super twisted nematic (STN), twisted nematic (TN), in-plane switching (IPS), vertically aligned (VA), optically compensated birefringence (OCB), or axially symmetric aligned micro (ASM) LCD to increase viewing angles.

11. A method for forming an optical compensation film of C+A plate type, the method characterized by:
dissolving a predetermined percentage of polyimide homogeneously in a solvent according to required properties to obtain a solution, wherein a structure of the polyimide is a biphenyl structure without fluorine; and
spreading the solution on at least one surface of a substrate and re-extending the substrate to form an optical compensation film of C+A plate type.

12. The method of claim 11, wherein the solvent is selected from the group consisting of alkyl halides, aromatic, ketone ring, ethers, ketone and combination thereof.

13. The method of claim 12, wherein the alkyl halide is selected from the group consisting of dichloromethane, dichloroethane, trichloroethane and tetrachloroethane.

14. The method of claim 12, wherein the aromatic is toluene.

15. The method of claim 12, wherein the ketone ring is cyclopentanone or cyclohexanone.

16. The method of claim 12, wherein the ether is tetrahydrofuran (THF).

17. The method of claim 12, wherein the ketone is selected from the group consisting of acetone, methyl-ethyl ketone (MEK), methyl-isobutyl ketone (MIBK), methyl-isoproyl ketone (MIPK), 1-methyl pyrrolidone (NMP) and dimethyl sulfoxide (DMSO).
